(19) United States
(12) Patent Application Publication
(10) Pub. No.: US 2022/0051117 A1
(43) Pub. Date: Feb. 17, 2022

(54) FIELD DATA MONITORING DEVICE, FIELD DATA MONITORING METHOD, AND FIELD DATA DISPLAY DEVICE

(71) Applicant: Hitachi, Ltd., Tokyo (JP)

(72) Inventors: Kazuo MUTO, Tokyo (JP); Takayuki UCHIDA, Tokyo (JP)

(21) Appl. No.: 17/152,262

(22) Filed: Jan. 19, 2021

(30) Foreign Application Priority Data
Aug. 11, 2020 (JP) 2020-135806

(51) Int. Cl. G06N 5/04; G06F 16/23; G06F 11/07; G06N 7/00; G06N 5/02; G06N 20/00

(52) U.S. Cl. CPC G06N 5/04; G06F 16/2379; G06F 11/0736; G06N 20/00; G06F 11/0787; G06N 7/005; G06N 5/02; G06F 11/0751

(57) ABSTRACT

A field data monitoring device comprises a field data database which accumulates field data; a failure mode database which records a failure mode list and a failure-mode word-probability table, the failure mode list recording names of failure modes of products and occurrence probabilities of the failure modes, and the table holding appearance probabilities of words in the field data; a design production operation database which accumulates data of the products; a failure-mode estimating section that calculates attribution probabilities of the field data to the failure modes based on the occurrence probabilities and the appearance probabilities, the failure-mode estimating section classifying the field data according to the failure modes; and a failure-mode cause finding section that extracts conditions under which the failure modes easily occur, the conditions being extracted from the data in the design production operation database and of the products associated with the classified field data.

### CLAIM OF PRIORITY

The present application claims priority from Japanese Patent Application JP 2020-135806 filed on Aug. 11, 2020, the content of which is hereby incorporated by reference into this application.

### BACKGROUND OF THE INVENTION

The present invention relates to a technique for supporting product design and particularly to a technique for supporting finding of a cause of a failure in a product by collecting and analyzing a maintenance record. To design various products, it is important to obtain sufficient knowledge about the reliability of components composed of the products. Regarding this point of view, sensor data, maintenance records related to inspections, monitoring, and repairs, and field data of customer complaints and the like include information on the product reliability in the market. It is therefore considered that the product reliability can be improved by analyzing the field data, identifying a component that frequently fails and a cause of the failure, and making design improvements at the time of the design of the various products based on the analysis and the identification.

On the other hand, document JP 2000-155700 proposes a quality information collection and diagnosis device that extracts accumulated field data under various conditions, displays the field data using a transition chart, a bar graph, a Pareto chart, and the like and supports finding of a cause of a failure. According to JP 2000-155700, it is possible to display a change in a failure rate over time and the like for each of categories such as a “product type” and a “component”.

Document JP 2019-116377 proposes a method for estimating, based on described details of field data, a failure mode that corresponds to the field data and is among failure modes defined in advance.

With the technique disclosed in JP 2000-155700, in order to find a cause of a failure, not only a product type but also information is required including on what kind of failure modes have increased in number, such as “screw falling-off”. The technique disclosed in JP 2019-116377 has a problem that it is difficult to define all failure modes in advance.

### SUMMARY OF THE INVENTION

Under the foregoing circumstances, the present invention aims to provide a field data monitoring device, a field data monitoring method, and a field data display device that improve the accuracy of finding of a cause of a failure. The present invention also aims to provide a field data monitoring device, a field data monitoring method, and a field data display device that are able to quickly recognize a major failure by detecting a new failure mode and to reduce the number of system management processes by adding a new failure mode.

The present invention provides a field data monitoring device comprising: a field data database in which field data is accumulated; a failure mode database in which a failure mode list and a failure-mode word-probability table are recorded, the failure mode list recording names of failure modes of products and occurrence probabilities of each of the failure modes, and the failure-mode word-probability table holding appearance probabilities of words described in the field data for each of the failure modes; a design production operation database in which data on design, production, and operations of the products is accumulated; a failure-mode estimating section that calculates attribution probabilities of the field data to each of the failure modes based on information of the occurrence probabilities of the failure modes and the appearance probabilities of the words in the failure mode database, the failure-mode estimating section classifying the field data according to the failure modes based on results of calculating the attribution probabilities; and a failure-mode cause finding section that extracts conditions under which the failure modes easily occur, the conditions being extracted from the data accumulated in the design production operation database, the data being data of the products associated with the field data classified by the failure-mode estimating section.

The present invention also provides a field data monitoring method comprising the steps of: preparing a field data database in which field data is accumulated, a failure mode database in which a failure mode list and a failure-mode word-probability table are recorded, the failure mode list recording names of failure modes of products and occurrence probabilities of each of the failure modes, and the failure-mode word-probability table holding appearance probabilities of words described in the field data for each of the failure modes, and a design production operation database in which data on design, production, and operations of the products is accumulated; calculating attribution probabilities of the field data to each of the failure modes based on information of the occurrence probabilities of the failure modes and the appearance probabilities of the words in the failure mode database, and classifying the field data according to the failure modes based on results of calculating the attribution probabilities, and extracting conditions under which the failure modes easily occur, the conditions being extracted from the data accumulated in the design production operation database and indicating the products associated with the classified field data.

The present invention also provides a field data display device that configures a display screen of a product by using field data, wherein the field data includes at least information of items related to states of failures of the product when maintenance related to a failure of the product is performed, wherein the field data display device classifies the field data into clusters based on appearance numbers of times of words used in the items for each of the items, and wherein the field data display device displays the classified field data on the display screen in chronological order or with lines.

The present invention also provides a field data display device that configures a display screen of a product by using field data, wherein the field data includes at least information of items related to states of failures of the product when maintenance related to a failure of the product is performed, wherein the field data display device classifies the field data into clusters based on appearance numbers of times of words used in the items for each of the items, and wherein the field data display device displays a list of the items of the classified field data on the display screen.

The present invention also provides a field data display device that configures a display screen of a product by using field data, wherein, for a failure mode to be analyzed, the field data display device extracts a combination of characteristic amounts with high probabilities of failure from the field data of the failure mode and design production data of the product and displays a name of the failure mode and a condition under which a failure easily occurs on the display screen.

The present invention also provides a field data display device that configures a display screen of a product by using field data, wherein the field data display device displays, based on information of appearance probabilities of words used in the field data, the field data including the attribution probabilities to each of the failure modes and information entropy calculated from the attribution probabilities to each of the failure modes, wherein the field data display device displays the attribution probabilities to each of the failure modes and the information entropy for each of the field data on the display screen, and wherein the information entropy is represented by values indicating a variation in the attribution probabilities to the failure modes.

According to the present invention, it is possible to improve the accuracy of finding of a cause of a failure, quickly recognize a major failure by detecting a new failure mode, and reduce the number of system management processes by adding a new failure mode.

### BRIEF DESCRIPTION OF THE DRAWINGS

FIG. 1 is a diagram illustrating an example of a schematic configuration of a field data monitoring device according to a first embodiment of the invention;

FIG. 2 is a diagram illustrating usage relationships between processing functions of an arithmetic processing unit and databases in the first embodiment;

FIG. 3 is a diagram illustrating an example of field data accumulated in a field data database;

FIG. 4 is a diagram illustrating an example of a data configuration of a failure mode database;

FIG. 5 is a diagram illustrating an example of a failure-mode word-probability table;

FIG. 6 is a diagram illustrating an example of information recorded in a design production operation database;

FIG. 7 is a diagram illustrating a process flow of initial building of failure mode data;

FIG. 8 is a diagram illustrating a detailed process flow of a process step S701 illustrated in FIG. 7;

FIG. 9 is a diagram illustrating an example of a screen displayed on an output unit in a process step S703 illustrated in FIG. 7;

FIG. 10 is a diagram illustrating an example of a screen displayed on the output unit in the process step S703 illustrated in FIG. 7;

FIG. 11 is a diagram illustrating the flow of a process of analyzing a cause of a failure;

FIG. 12 is a diagram illustrating an example of a screen displayed on the output unit in a process step S1105 illustrated in FIG. 11;

FIG. 13 is a diagram illustrating the flow of a process of registering a new failure mode;

FIG. 14 is a diagram illustrating an example of a screen displayed on the output unit in a process step S1303 illustrated in FIG. 13;

FIG. 15 is a diagram illustrating an example of a screen displayed when a failure mode is added;

FIG. 16 is a diagram illustrating an example of a schematic configuration of a field data monitoring device according to a second embodiment of the invention;

FIG. 17 is a diagram illustrating usage relationships between processing functions of an arithmetic processing unit and the databases in the second embodiment;

FIG. 18 is a diagram describing the flow of a process of detecting a change in the tendency of the occurrence of a failure mode;

FIG. 19 is a diagram illustrating an example of attribution probabilities calculated by a failure-mode estimating section; and

FIG. 20 is a diagram illustrating an example of results of calculating failure probabilities.

### DETAILED DESCRIPTION OF THE PREFERRED EMBODIMENTS

Hereinafter, embodiments of the invention are described with reference to the drawings.

### First Embodiment

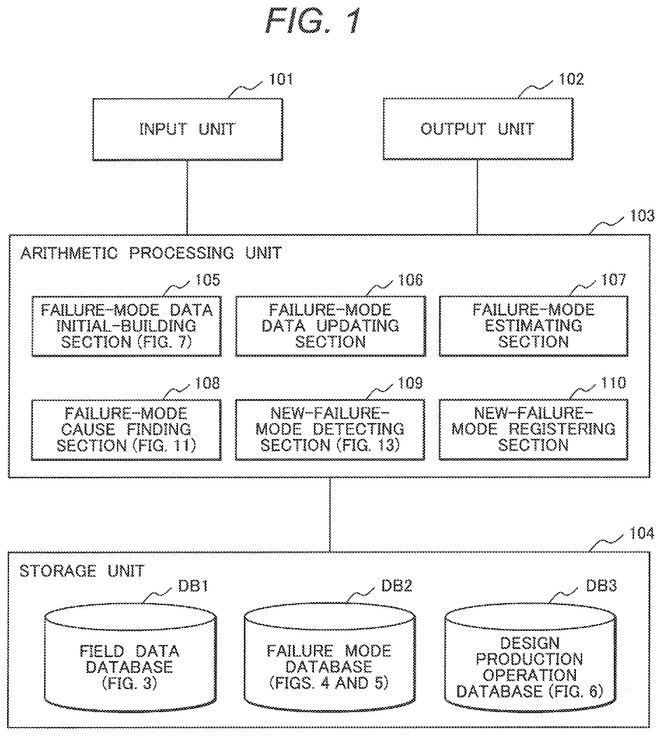

FIG. 1 illustrates an example of a schematic configuration of a field data monitoring device according to a first embodiment of the invention. The field data monitoring device is configured with a computer and includes an input unit 101, an output unit 102, an arithmetic processing unit 103, and a storage unit 104.

The input unit 101 is composed of various input devices such as a keyboard, a mouse, and a touch panel and is used by a user of the field data monitoring device to input data to the field data monitoring device.

The output unit 102 is an output device such as a display device and displays a screen for an interactive process with the arithmetic processing unit 103.

The storage unit 104 is, specifically, a hard disk, a solid state drive, or the like and includes a field data database DB1, a failure mode database DB2, and a design production operation database DB3.

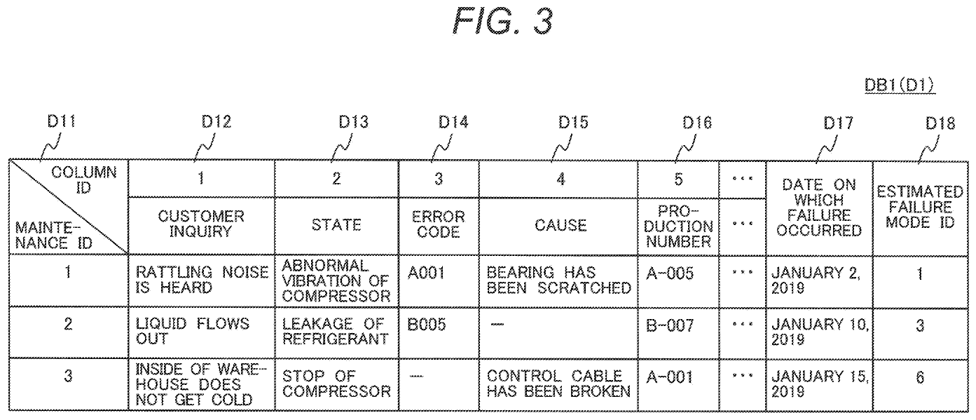

In the field data database DB1, various field data D1 that includes complaints from customers, error logs output from the device, maintenance records, and the like and is information on product reliability in the market is accumulated. FIG. 3 illustrates an example of the accumulated field data D1.

In the field data D1 exemplified in FIG. 3, a maintenance ID (D11) serving as a key, a customer inquiry D12 received from a customer and related to a failure of a device, a state D13 of the failure of the device at the time of maintenance, a cause D15 of the failure of the device at the time of the maintenance, an error code D14 output from the device, a date D17 when the failure occurred, and the like are recorded. In addition, information that is a production number D16 or the like and identifies the failed device is associated and stored. An estimated failure mode ID (D18) is given to the maintenance ID (D11).

In a case example in which the maintenance ID (D11) illustrated in FIG. 3 is “1”, the customer inquiry D12 from the customer indicates an abnormal sound, the state D13 of the failure of the device at the time of the maintenance indicates an abnormal vibration of a compressor, the cause D15 of the failure of the device is a scratch of a bearing, the error code D14 output from the device is A001, and the estimated failure mode ID (D18) can be estimated to be “1”.

Case examples in which the maintenance ID (D11) illustrated in FIG. 3 is “2” and “3” are illustrated in FIG. 3 and are not described below. In the case example in which the maintenance ID (D11) is “2”, maintenance is not yet performed, or maintenance is being performed but the cause of a failure is not yet identified, or the cause has been identified but a person responsible for the maintenance has not yet completely input information. The case example in which the maintenance ID (D11) is “3” indicates that an error code is not yet set. The case examples in which the maintenance ID (D11) is “2” and “3” indicate that the estimated failure mode ID (D18) can be estimated to be “3” and “6”.

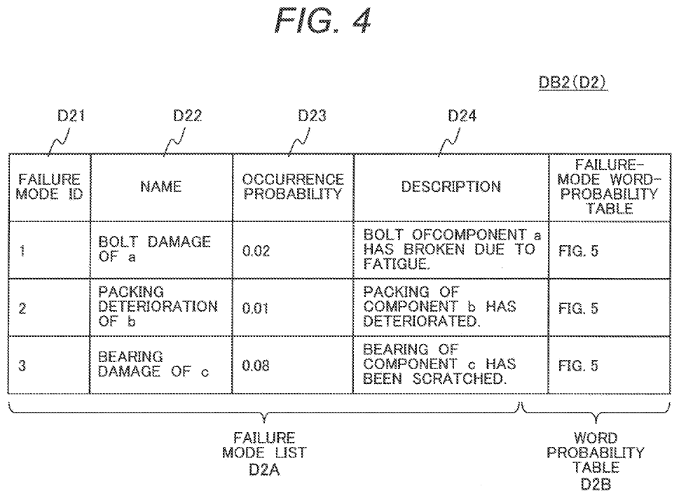

FIG. 4 illustrates an example of a data configuration of the failure mode database DB2. In the failure mode database DB2 illustrated in FIG. 4, a list D2A of failure modes that may occur and a failure-mode word-probability table D2B are accumulated. The failure-mode word-probability table D2B indicates words and items that are described in the field data D1 and probabilities that the words and the items are described.

In the list D2A of the failure modes that is included in information accumulated in the failure mode database DB2 illustrated in FIG. 4, a failure mode name D22 and an occurrence probability D23 are recorded for each failure mode ID (D21). Additional information related to the failure modes and indicating descriptions D24 of the failure modes or the like may be recorded.

For example, in FIG. 4, information indicating that a failure mode name D22 associated with a failure mode ID (D21) indicating “1” is “bolt damage of a” and an occurrence probability D23 is 0.02 is recorded. Case examples in which the failure mode ID (D21) illustrated in FIG. 4 is “2” and “3” are illustrated in FIG. 4 and are not described below. A failure-mode word-probability table D2B is given as a pair of information items to each information item (information when the failure mode ID (D21) is “1”, “2”, and “3”) of the list D2A of the failure modes for each information item.

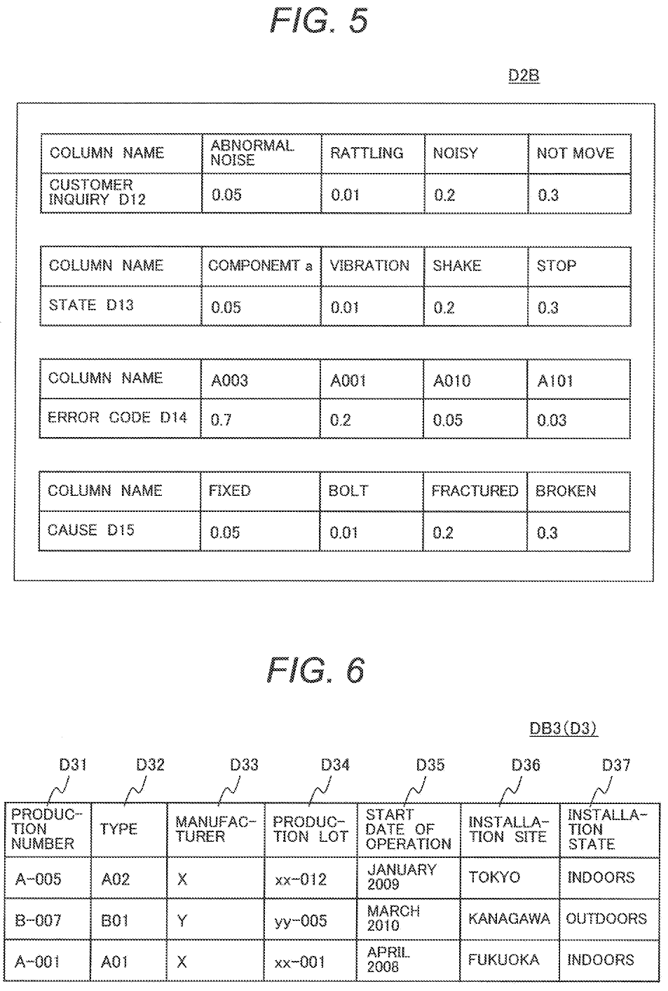

FIG. 5 illustrates an example of the failure-mode word-probability table D2B at the time of the “bolt damage of a” associated with the failure mode ID indicating “1” and illustrated in FIG. 4. Although the failure-mode word-probability table D2B at the time of “packing deterioration of b” associated with the failure mode ID indicating “2” and illustrated in FIG. 4 or the failure-mode word-probability table D2B at the time of “bearing damage of c” associated with the failure mode ID indicating “3” and illustrated in FIG. 4 is prepared in the same format as that illustrated in FIG. 5, the failure modes are different and thus values of word probabilities indicated in columns are different.

In the table format illustrated in FIG. 5, four columns for customer inquiries, states, error codes, and causes are included and correspond to D12, D13, D14, and D15 of the field data D1 illustrated in FIG. 3. Each of the columns relates to, for example, a character string described in each of cells of the customer inquiry D12 illustrated in FIG. 3. In each of the columns, words frequently used and extracted and probabilities that the words are used are represented. Specifically, as the character strings described in the cells of the customer inquiry D12, “abnormal sound”, “rattling”, “noisy”, “not move”, and the like frequently appear. Probabilities that the character strings are used are represented as values. In the other items that are the state D13, the error code D14, and the cause D15, values indicating probabilities that character strings are used are represented by the same analysis.

In the failure-mode word-probability table D2B illustrated in FIG. 5, words and probabilities that the words are described are stored in the columns of the field data D1 when a certain failure mode occurs. For example, in FIG. 5, information indicating that when the failure mode “bolt damage of a” occurs, the word “abnormal sound” is described with a probability of 0.05 is recorded in the “customer inquiry” column of the field data. Hereinafter, the list D2A of the failure modes and failure-mode word-probability table D2B are collectively referred to as failure mode data D2.

FIG. 6 illustrates an example of information D3 recorded in the design production operation database DB3. In the design production operation database DB3, information that is a production number D31 or the like, identifies a device, and serves as a key, and information that is related to an operation of the product are recorded. The information related to the operation of the product includes a type D32, a manufacturer D33, information D34 that indicates a component used, a production lot, and the like and relates to design and production of the product, an installation site 36, and an installation state D37.

The databases DB1, DB2, and DB3 share some of stored information and can be referenced by each other. Information that serves as keys for enabling the databases to coordinate with each other is the failure mode IDs (D18 and D21), the customer inquiry D12, the state D13, the error code D14, the cause D15, the production numbers (D16 and D31), and the like.

Returning to FIG. 1, the arithmetic processing unit 103 is composed of a central processing unit (CPU) and executes information processing in the filed data monitoring device. When processing functions of the arithmetic processing unit 103 are represented as sections, the arithmetic processing unit 103 includes a failure-mode data initial-building section 105, a failure-mode data updating section 106, a failure-mode estimating section 107, a failure-mode cause finding section 108, a new-failure-mode detecting section 109, and a new-failure-mode registering section 110.

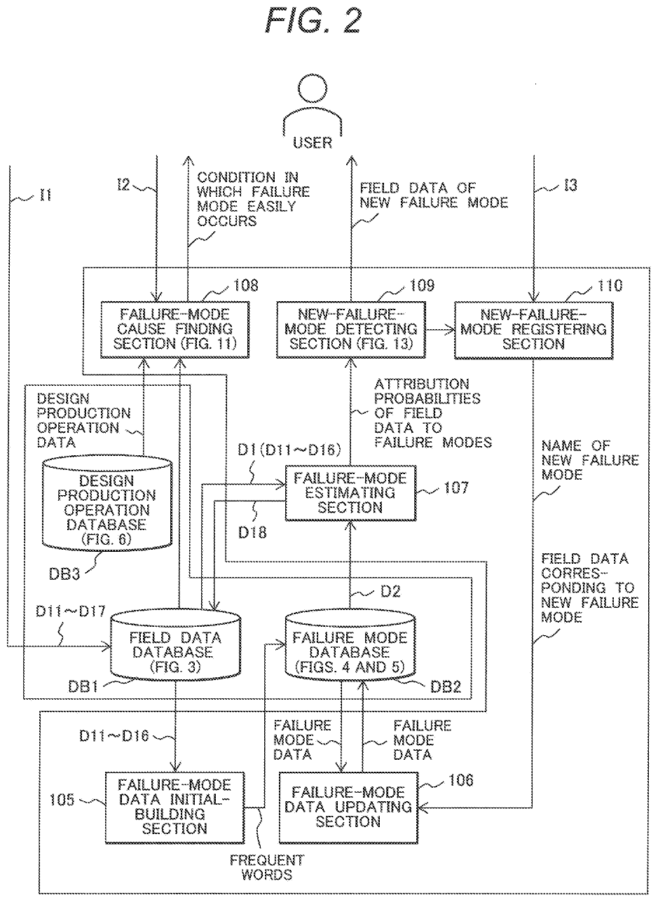

FIG. 2 illustrates usage relationships between the processing functions of the arithmetic processing unit 103 and the databases. Details of processes of the processing functions are described with reference to FIG. 2. Although the input unit 101 and the output unit 102 are not illustrated, the user operates the arithmetic processing unit 103 via the input unit 101 and the output unit 102 and checks displayed details.

An initial process given by the user to the field data monitoring process via the input unit 101 is to input the field data D1 including the items D11 to D17 illustrated in FIG. 3 to the field data database DB1 and accumulate the field data D1 in the field data database DB1, via an input signal I1. In this input process, new field data D1 is accumulated at an appropriate time after the new field data D1 is obtained. At this time, information of the estimated failure mode ID (D18) is not given.

When the data accumulation in the field data database DB1 is in the aforementioned initial state, the failure-mode data initial-building section 105 within the field data monitoring device acquires the customer inquiry D12, the state D13, the error code D14, and the cause D15 from the field data D1 accumulated in the field data database DB1 and illustrated in FIG. 3 and extracts words frequently used from the columns of the acquired items that are used in the failure-mode word-probability table D2B illustrated in FIG. 5. For example, in the example illustrated in FIG. 5, the failure-mode data initial-building section 105 extracts frequent words such as “abnormal sound”, “rattling”, “noisy”, and “not move” as words of the column of the customer inquiry D12. Then, the failure-mode data initial-building section 105 stores the obtained frequent words in the failure-mode word-probability table D2B within the failure mode database DB2.

The failure-mode estimating section 107 receives the failure mode data D2 accumulated in the failure mode database DB2 and the field data D1 accumulated in the field data database DB1 and calculates attribution probabilities of each of the field data D1 to each of the failure modes.

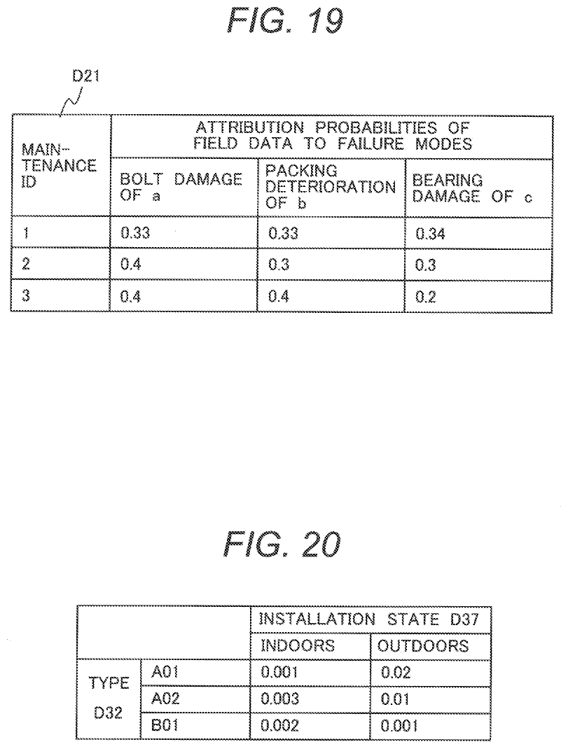

FIG. 19 illustrates an example of the calculated attribution probabilities. From FIG. 19, it is found that a probability that the field data D1 in which the maintenance ID (D21) is “1” belongs to the failure mode “bolt damage of a” is 0.33, a probability that the field data D1 in which the maintenance ID (D21) is “1” belongs to the failure mode “packing deterioration of b” is 0.33, and a probability that the field data D1 in which the maintenance ID (D21) is “1” belongs to the failure mode “bearing damage of c” is 0.34.

The failure-mode estimating section 107 stores the failure mode to which the field data belongs with the highest attribution probability as an estimated failure mode in the estimated failure mode ID (D18) of the field data database DB1. For example, the attribution probabilities are calculated as illustrated in FIG. 19, an estimated failure mode associated with the maintenance ID indicating 1 in the field data is determined to be “bearing damage of c” and is stored in the estimated failure mode ID (D18) of the field data database DB1.

The failure-mode cause finding section 108 receives an input signal 12 including a failure mode specified by the user of the field data monitoring device and to be analyzed, the field data D1 accumulated in the field data database DB1, and the design production operation data D3 accumulated in the design production operation database DB3 and presents, to the user, a condition for design, production, and an operation. In the condition, the failure mode to be analyzed easily occurs.

The new-failure-mode detecting section 109 receives the attribution probabilities, calculated by the failure-mode estimating section 107, that the failure data D1 belongs to the failure modes to detect field data D1 not included in the failure mode list of the failure mode database DB2 and corresponding to a new failure mode. Then, the new-failure-mode detecting section 109 presents the detected field data D1 to the user. In order to check details of the new failure mode, the user to which the presence of the new failure mode has been presented regards the new failure mode as the aforementioned failure mode to be analyzed and gives the input signal 12 to the failure-mode cause finding section 108. This operation may lead to a solution to a cause of the failure mode.

The new-failure-mode registering section 110 receives user's input of the name of the new failure mode from an input signal 13, acquires a result of selecting field data corresponding to the new failure mode, and outputs the received information and the acquired result to the failure-mode data updating section 106.

The failure-mode data updating section 106 receives the name of the new failure mode from the new-failure-mode registering section 110 and updates failure mode data accumulated in the failure mode database DB2 from the field data corresponding to the new failure mode.

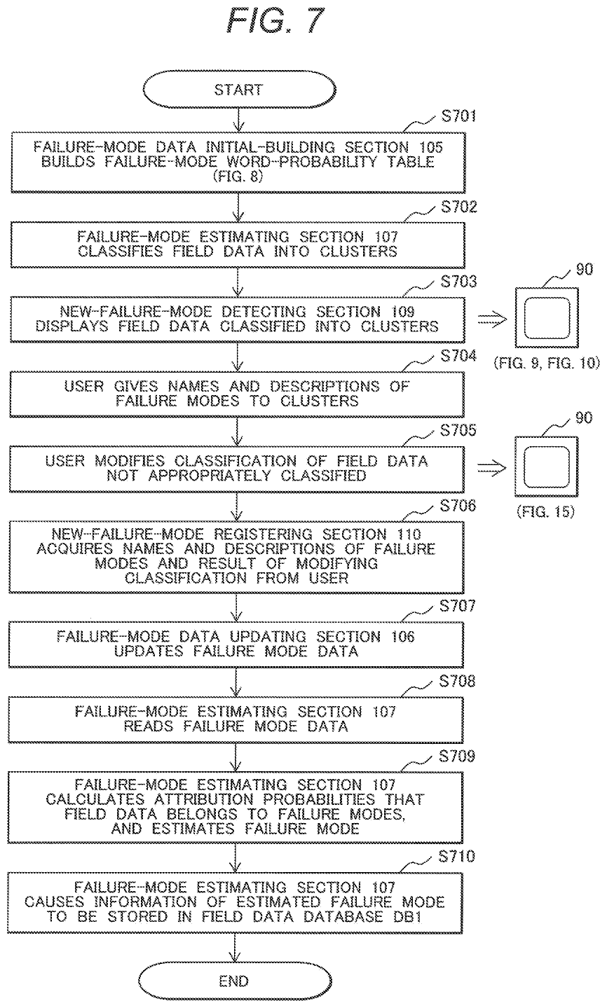

Processes to be performed by the field data monitoring device include three processes: failure mode data initial building, failure mode cause analysis, and new failure mode detection. The failure mode data initial building process is described in detail with reference to a process flow of the failure mode data initial building illustrated in FIG. 7.

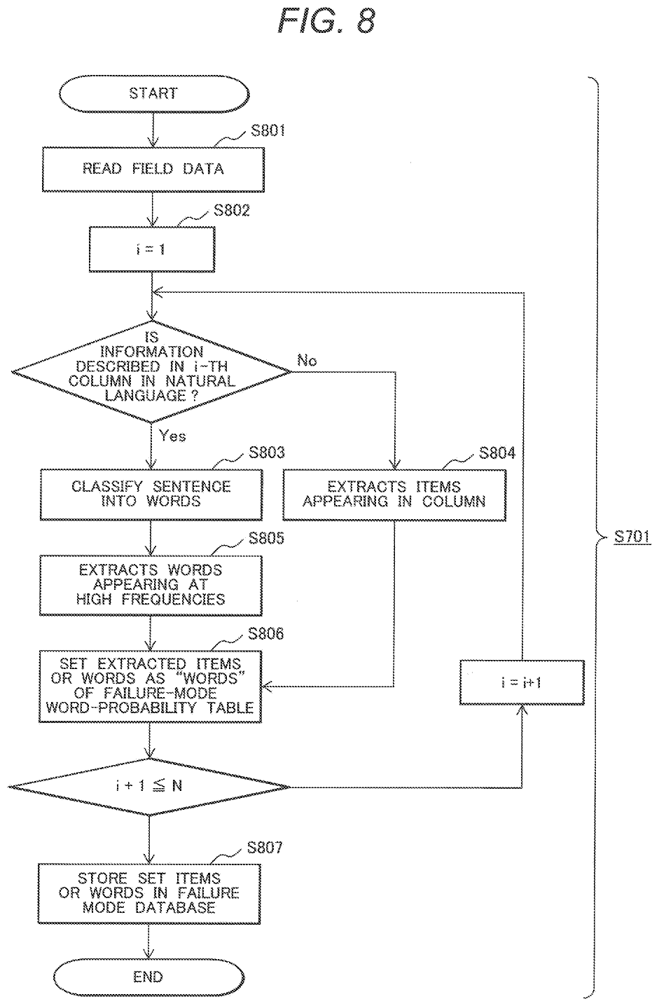

An initial process step S701 illustrated in FIG. 7 corresponds to the failure-mode data initial-building section 105. In the process step S701, the failure-mode data initial-building section 105 extracts words used in the failure-mode word-probability table D2B of the failure mode data D2 from character strings described in the customer inquiry D12 from the customer, the state D13 of the failure of the device at the time of the maintenance, the cause D15 of the failure of the device, and the error code D14 output from the device. FIG. 8 illustrates details of the process step S701.

In an initial process step S801 of FIG. 8 illustrating the detailed process by the failure-mode data initial-building section 105, the failure-mode data initial-building section 105 reads the field data D1 from the field data database DB1. In a process step S802, the failure-mode data initial-building section 105 sets a counter i to “1”.

When information described in an i-th column of the field data is an error code or the like and is not in a natural language in a process step S803, the process proceeds to a process step S804 and the failure-mode data initial-building section 105 extracts all items appearing in the column. On the other hand, when the information described in the i-th column of the field data is in the natural language, the failure-mode data initial-building section 105 divides a sentence into words in the process step S804 and extracts words appearing at high frequencies in a process step S805.

In a process step S806, the failure-mode data initial-building section 105 sets the items extracted in the process step S804 or the words extracted in the process step S805 as words of the failure-mode word-probability table D2B illustrated in FIG. 5. In a process step S807, the failure-mode data initial-building section 105 stores the set items or the set words in the failure mode database DB2. The series of processes are continuously performed until words are completely extracted from all the columns while the value of the counter i is updated.

Returning to FIG. 7, a process step S702 corresponds to the failure-mode estimating section 107. In the process step S702, the failure-mode estimating section 107 classifies the field data D1 into clusters based on described details of the field data D1. Specifically, the failure-mode estimating section 107 calculates, for each field data, the number of times that each of words of the failure-mode word-probability table D2B stored in the failure mode database DB2 has appeared. Then, the failure-mode estimating section 107 classifies the field data D1 into the clusters based on differences between the numbers of times that the words have appeared. The number of clusters into which the field data D1 is classified may be specified by the user in advance. Alternatively, the user may divide the field data into teacher data and learning data, calculate perplexities or evaluation indices for a topic model, and use the number of clusters for while the smallest perplexity has been calculated.

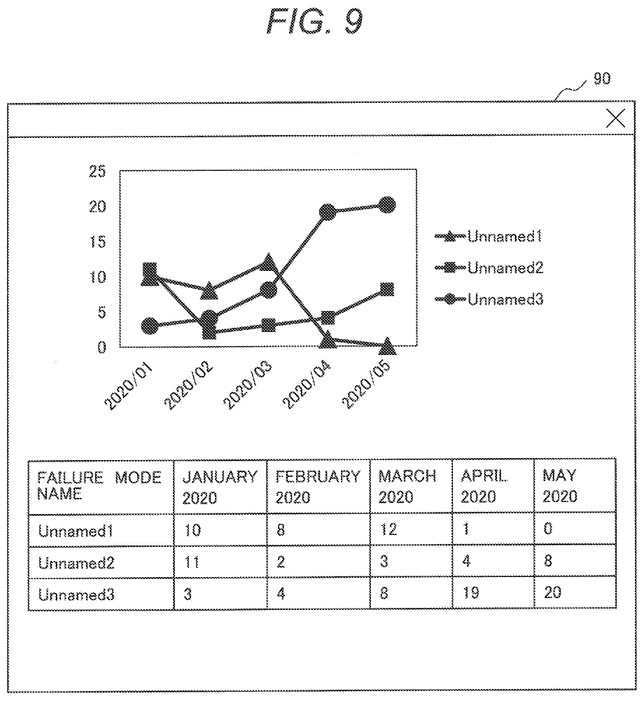

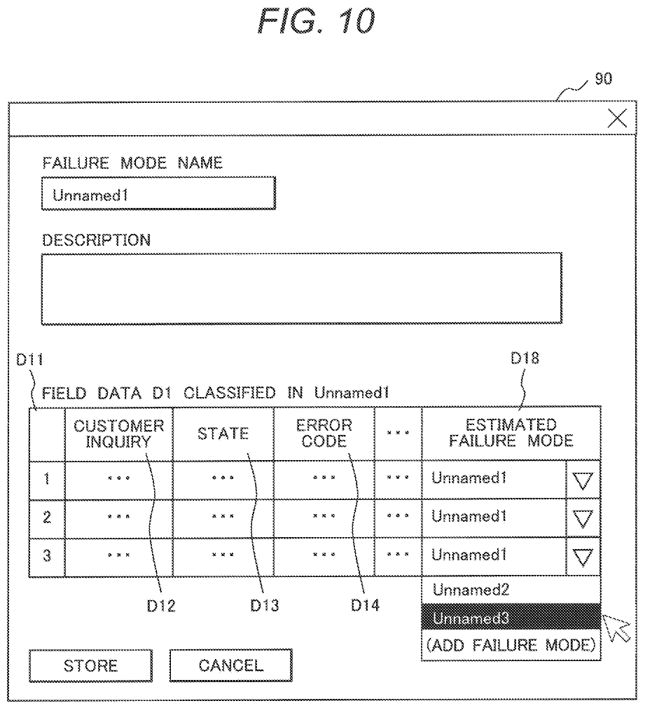

A process step S703 corresponds to the new-failure-mode detecting section 109. In the process step S703, the new-failure-mode detecting section 109 displays the field data D1 classified in the clusters on the output unit 102. FIGS. 9 and 10 illustrate examples of screens displayed by the new-failure-mode detecting section 109 on the output unit 102.

On a screen 90 illustrated in FIG. 9, the transition of new failure modes is chronologically displayed with broken lines and data on upper and lower sides of the screen 90. The field data D1 is classified into three clusters, and failure modes corresponding to the clusters are tentatively named Unnamed1, Unnamed2, and Unnamed3 that are displayed on the screen 90. When data of dates on which failures have occurred is included in the field data, a change in the number of failure-occurrence over time may be displayed with a line graph, a table, or the like.

On a screen 90 illustrated in FIG. 10, a screen for editing a name of a failure mode and a description of the failure mode, a list of the field data D1 classified in the clusters, and process buttons for storage, cancellation, and the like are displayed. The screen illustrated in FIG. 9 can transition to the screen illustrated in FIG. 10 when, for example, the user uses a mouse or the like to click a failure mode name illustrated in FIG. 9.

A process step S704 illustrated in FIG. 7, the user gives a name of a failure mode and a description of the failure mode to each of the clusters. For example, on the screen 90 illustrated in FIG. 10, the user inputs the name of the failure mode and the description of the failure mode while referencing the field data D1 classified in the cluster corresponding to the failure mode tentatively named Unnamed1.

In a process step S705, when field data D1 that has been classified into an incorrect cluster exists, the user modifies the classification. For example, as illustrated in FIG. 10, the failure modes corresponding to the field data D1 may be selected by pulling-down or the like. When a corresponding failure mode does not exist, the failure mode may be added. For example, in the pulling-down illustrated in FIG. 10, an option “add new failure mode” may be added and the failure mode may be added.

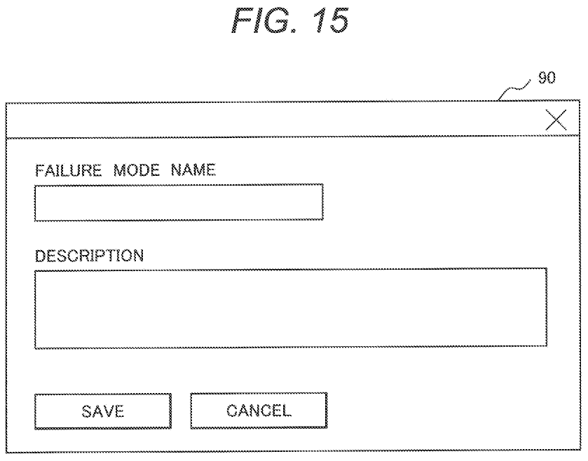

FIG. 15 illustrates an example of a screen displayed when a failure mode is added. In the example of the screen 90 illustrated in FIG. 15, when the name of a failure mode and a description of the failure mode are input and the save button is pressed, the new failure mode is added.

A process step S706 corresponds to the new-failure-mode registering section 110. In the process step S706, the new-failure-mode registering section 110 acquires the name and description, input in the process step 704, of the failure mode and a result of modifying the classification in the process step S705.

A process step S707 corresponds to the failure-mode data updating section 106. In the process step S707, the failure-mode data updating section 106 updates the failure mode data based on the name of the failure mode, the description of the failure mode, and the result of modifying the classification and stores results of updating the failure mode data in the failure mode data database DB2.

A process step S708 corresponds to the failure-mode estimating section 107. In the process step S708, the failure-mode estimating section 107 reads the failure mode data D2 from the failure mode database DB2. In a process step S709, the failure-mode estimating section 107 calculates, based on the read failure mode data D2, attribution probabilities of each of the field data to each of the failure modes, and the failure-mode estimating section 107 treats, as the estimating failure mode D18, a failure mode to which the field data belongs with the highest attribution probability.

Lastly, in a process step S710, the failure-mode estimating section 107 stores the estimated failure mode D18 in the field data database DB1.

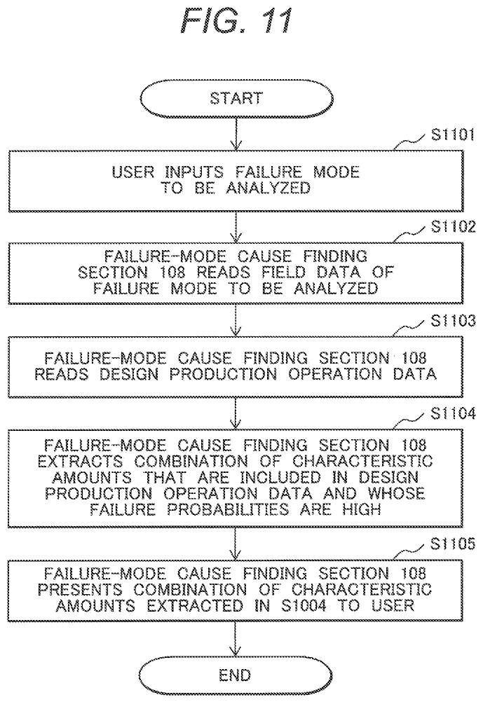

Next, the process of analyzing a cause of a failure mode is described. FIG. 11 illustrates the flow of the process of analyzing a cause of a failure. The completion of the failure mode data initial building process is a prerequisite for the process of analyzing a cause of a failure mode.

In the process (illustrated in FIG. 11) of analyzing a cause of a failure, in a process step S1101, the user uses the input unit 101 to input a failure mode to be subjected to the cause analysis via an input signal I1.

A process step S1102 corresponds to the failure-mode cause finding section 108. In the process step S1102, the failure-mode cause finding section 108 reads, from the field data database DB1, field data D1 in which the estimated failure mode matches the failure mode input in the process step S1101 and to be subjected to the cause analysis.

A process step S1103 corresponds to the failure-mode cause finding section 108. In the process step S1103, the failure-mode cause finding section 108 reads the design production operation data D3 from the design production operation database DB3.

A process step S1104 corresponds to the failure-mode cause finding section 108. In the process step S1104, the failure-mode cause finding section 108 extracts a combination of characteristic amounts that are included in the design production operation data D3 and whose failure probabilities are high. Specifically, the failure-mode cause finding section 108 treats, as the characteristic amounts, a column of the design production operation data D3 illustrated in FIG. 6 and calculates a failure probability for each of combinations of categories.

For example, FIG. 20 illustrates an example of results of calculating failure probabilities when a “type D32” and an “installation state D37” are used as characteristic amounts. FIG. 20 assumes that types can be classified into three categories A01, A02, and B01 and installation states can be classified into two categories, indoors and outdoors.

For example, a failure probability when the type is A01 and the installation state is indoors is calculated by dividing the total number of field data items, which match a failure mode to be subjected to the cause analysis and in which the type is A01 and the installation state is indoors, by the total number of field data items in which the type is A01 and the installation state is indoors. Then, the failure-mode cause finding section 108 uses, for example, a regression tree based on data of the calculated failure probability to extract characteristic amounts of design, production, and an operation data that easily cause a failure. A process step S1105 corresponds to the failure-mode cause finding section 108. In the process step S1105, the failure-mode cause finding section 108 displays a combination of the characteristic amounts extracted in the process step S1104 on the output unit 102.

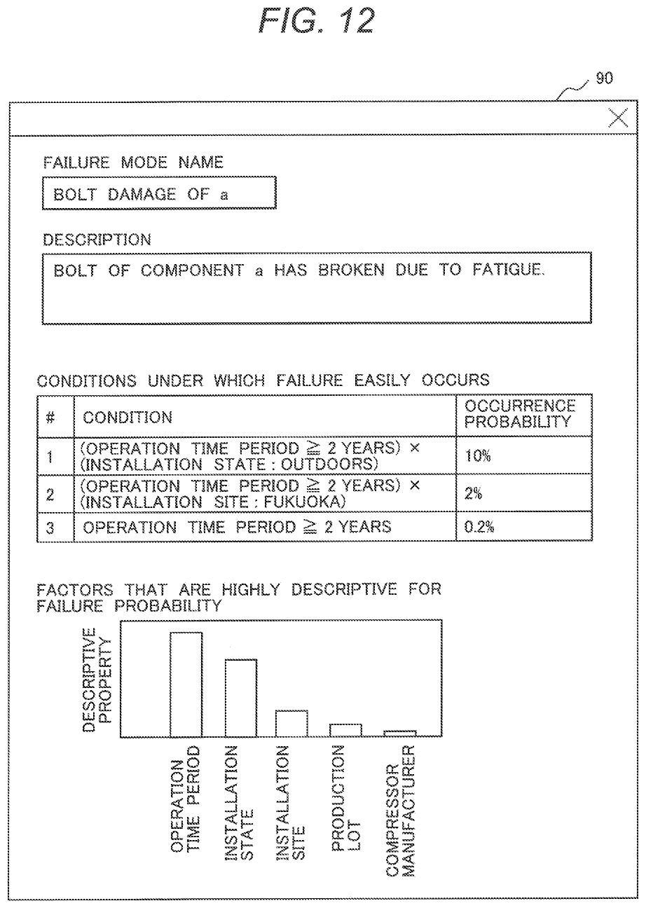

FIG. 12 illustrates an example of a screen displayed on the output unit 102. In FIG. 12, the failure mode “bolt damage of a”, a description of the failure mode “bolt damage of a”, and conditions (#1, #2, and #3) in which a failure easily occurs are displayed. For example, the condition #1 illustrated in FIG. 12 indicates that a probability that the failure mode “bold damage of a” occurs in a device that has operated for two years or more and whose installation state is outdoors is 10%. It is preferable that, in the displaying, factors that are highly descriptive for the failure probability be displayed together with the failure probability.

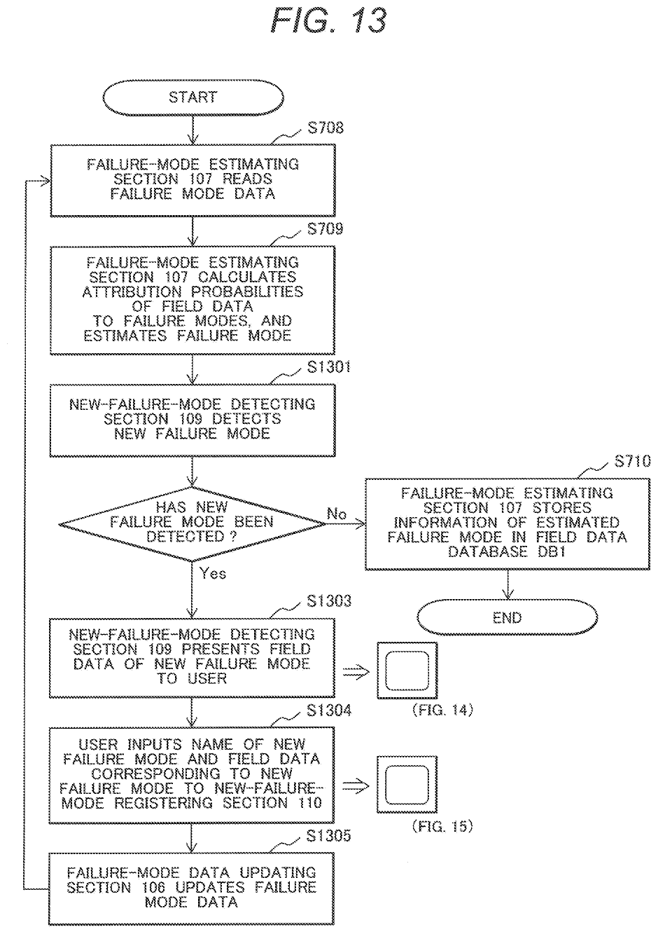

Next, the process of detecting a new failure mode is described. The completion of the failure mode data initial building process is a prerequisite for the process of detecting a new failure mode. FIG. 13 illustrates the flow of a process of registering a new failure mode. Processes that are included in the flow of the process illustrated in FIG. 13 and indicated by the same reference symbols as the processes (process steps S708, S709, and S710) illustrated in FIG. 7 described above are not described below.

A process step S1301 corresponds to the new-failure-mode detecting section 109. In the process (illustrated in FIG. 13) of registering a new failure mode, in the process step S1301, the new-failure-mode detecting section 109 detects a new failure mode based on attribution probabilities of each of the field data estimated in the process step S709 to each of the failure modes. Specifically, for example, the new-failure-mode detecting section 109 calculates information entropy from the attribution probabilities to each of the failure modes, and determines that field data whose information entropy is large may be a new failure mode.

When there are three failure modes, a failure mode 1, a failure mode 2, and a failure mode 3, and attribution probabilities of the field data to each of the failure modes 1, 2, and 3 are P1, P2, and P3, the information entropy can be calculated according to Formula (1).

−P1×log(P1)−P2×log(P2)−P3×log(P3) (1)

According to Formula (1), the information entropy has the following characteristic. That is, a calculated value of the information entropy in a second state in which the attribution probabilities P1, P2, and P3 of the failure modes 1, 2, and 3 are not largely different from each other or when the failure mode is hardly identified is larger than a calculated value of the information entropy when the attribution probability P1 of the failure mode 1 is close to 1 and the attribution probabilities P2 and P3 of the failure modes 2 and 3 are close to 0 or in a first state in which the failure mode can be estimated to be the failure mode 1. It is therefore possible to determine that a new failure mode is likely to have occurred.

When field data detected as a new failure mode exists, the new-failure-mode detecting section 109 presents the field data detected as the new failure mode to the user in a process step S1303 corresponding to the new-failure-mode detecting section 109.

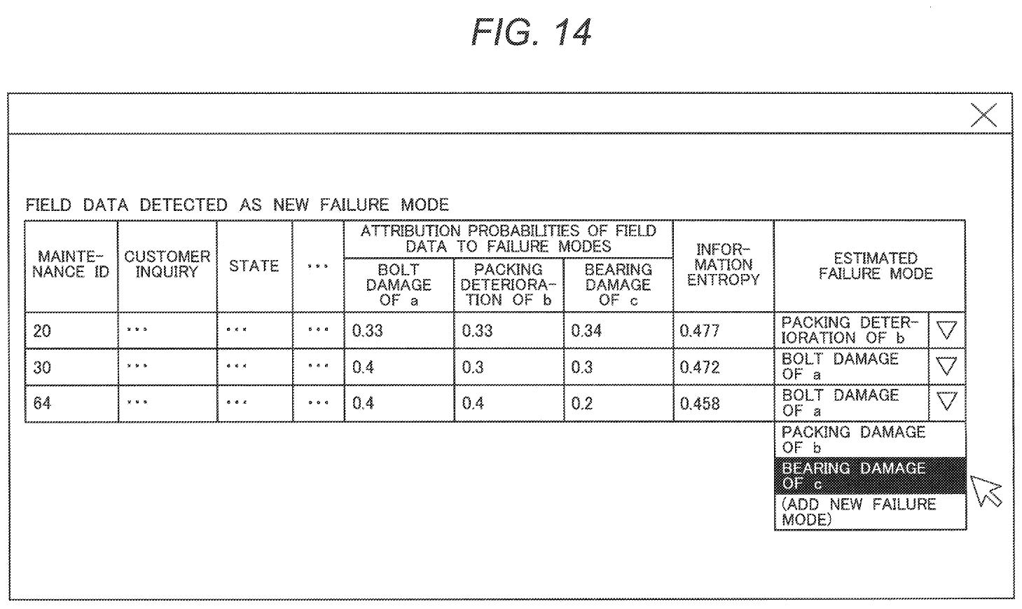

FIG. 14 illustrates an example in which the field data detected as the new failure mode is displayed on the output unit 102. In FIG. 14, three field data items that are included in the field data and whose information entropy is large are displayed. In this example, in three cases in which maintenance IDs are 20, 30, and 64, three attribution probabilities are close to each other. The three cases are represented in descending order of information entropy.

In a process step S1304, the user checks described details of the field data and inputs the name of the new failure mode and the field data corresponding to the new failure mode to the new-failure-mode registering section 110. For example, in FIG. 14, when the user checks the described details of the field data, and the field data indicate a new failure mode, the user selects “add new failure mode” by pulling down the column of the estimated failure mode.

After the selection, the new-failure-mode registering section 110 displays the screen illustrated in FIG. 15 and the user inputs the name of the new failure mode and a description of the new failure mode on the screen. Then, the user presses the save button to register the new failure mode. After the registration, the registered new failure mode is displayed in the column pulled down as illustrated in FIG. 14 and the estimated failure mode of the field data corresponding to the new failure mode is changed to the new failure mode registered via the pulling-down.

Then, the new-failure-mode registering section 110 gives the information input by the user in the process step S1304 to the failure-mode data updating section 106. In a process step S1305, the failure-mode data updating section 106 updates the failure mode data accumulated in the failure mode database DB2 based on the data.

Then, the process steps S708, S709, and S1301 are repeatedly performed until a new failure mode is not detected.

The three processes that are performed by the field data monitoring device according to the first embodiment of the invention and are the failure mode data initial building, the failure mode cause analysis, and the new failure mode detection are described above. When failure mode data on a similar device is already built, the failure mode cause analysis and the new failure mode detection may be performed using the failure mode data without the failure mode data initial building.

### Second Embodiment

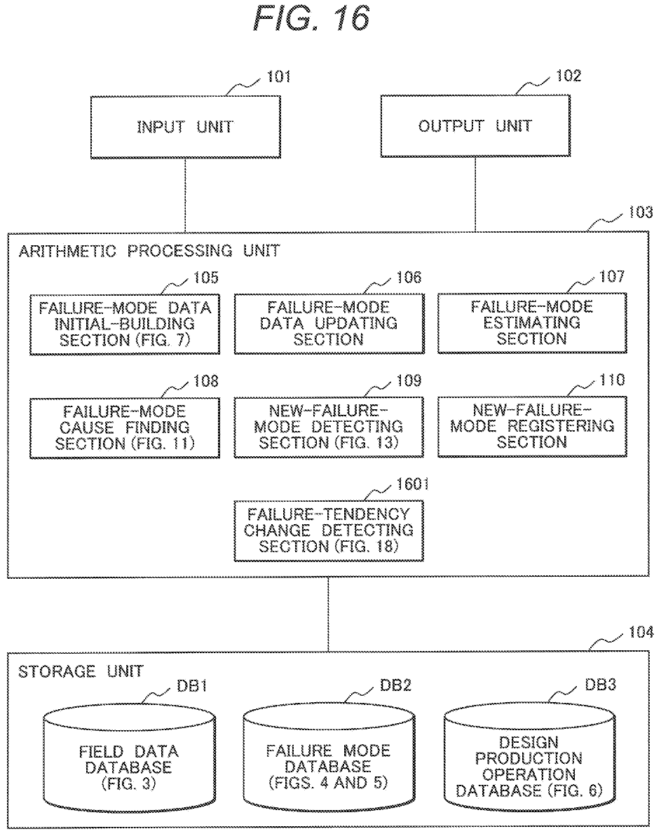

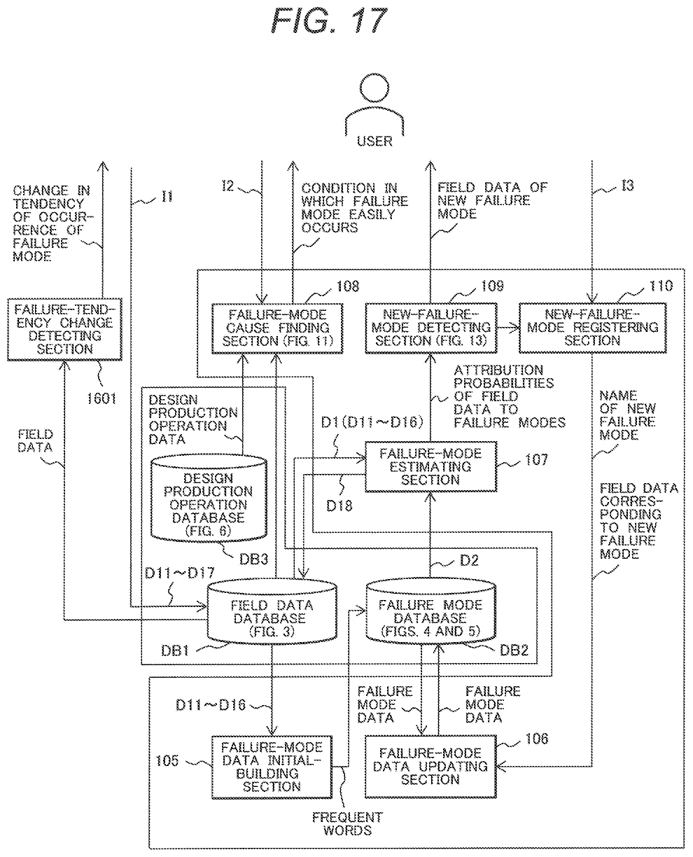

FIG. 16 is a diagram illustrating an example of a schematic configuration of a field data monitoring device according to a second embodiment of the invention. FIG. 17 is a diagram illustrating usage relationships between processing functions of an arithmetic processing unit 103 and the databases DB in the second embodiment. Units that are included in the field data monitoring device illustrated in FIG. 16 and have the same functions as those of the configurations indicated by the same reference signs are not described below. A difference between the first embodiment described with reference to FIGS. 1 and 2 and the second embodiment that is described below with reference to FIGS. 16 and 17 is that a failure-tendency change detecting section 1601 is newly installed in the arithmetic processing unit 103.

The failure-tendency change detecting section 1601 receives the field data D1 accumulated in the field data database DB1, detects a change in the tendency of the occurrence of a failure mode, and presents the detected change to a user.

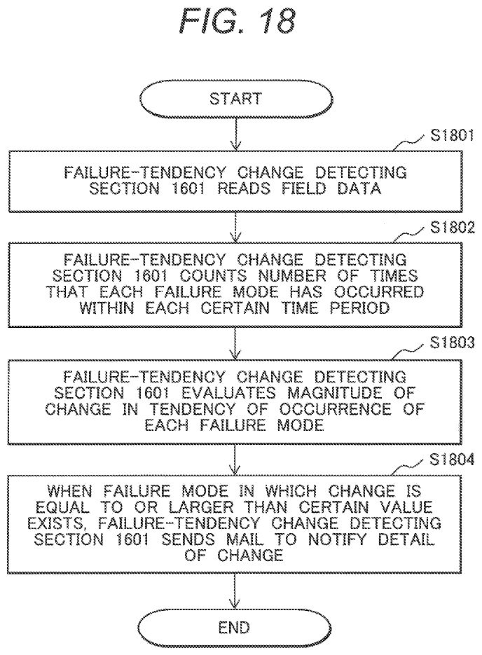

FIG. 18 illustrates the flow of a process of detecting a change in the tendency of the occurrence of a failure mode by the failure-tendency change detecting section 1601.

In a process step S1801, the failure-tendency change detecting section 1601 reads the field data D1 from the field data database DB1. In a process step S1802, the failure-tendency change detecting section 1601 uses information D18 recorded in the field data D1 and indicating an estimated failure mode to count the number of times that each failure mode has occurred within each certain time period of, for example, one month or the like.

Then, the failure-tendency change detecting section 1601 evaluates the magnitude of a change in the tendency of the occurrence of each failure mode. For example, the failure-tendency change detecting section 1601 uses the numbers of times that a certain failure mode has occurred within past three one-month time periods to estimate a probability distribution of the numbers of times that the failure mode has occurred with the three one-month time periods. Then, the failure-tendency change detecting section 1601 uses the estimated probability distribution to calculate a probability for the number of times that the latest failure mode has occurred. Specifically, when the number of times that the certain failure mode has occurred within the latest one-month time period is 3, the number of times that the certain failure mode has occurred within the second latest one-month time period is 4, and the number of times that the certain failure mode has occurred within the third latest one-month time period is 2, the probability distribution can be represented using a Poisson distribution in which the number of times that the certain failure mode has occurred per one month is 3. When the number of times that the certain failure mode has occurred within the latest one-month time period is 5, the probability can be calculated according to Formula (2), where e is a Napier's constant.

(3⁵×e⁻⁵)/5!≅0.014 (2)

Lastly, when a failure mode in which a change evaluated in the process step S1803 is equal to or larger than a certain value exists, the failure-tendency change detecting section 1601 determines that the tendency of the occurrence of the failure mode has changed, and sends a mail or the like to notify the detail of the change to the user in a process step S1804. Therefore, the user can quickly recognize that a specific failure mode has occurred frequently or recognize a failure mode that requires countermeasures, and it is possible to reduce a defective cost caused by a product failure.

### LIST OF REFERENCE SIGNS

101: Input unit
102: Output unit
103: Arithmetic processing unit
104: Storage unit
105: Failure-mode data initial-building section
106: Failure-mode data updating section
107: Failure-mode estimating section
108: Failure-mode cause finding section
109: New-failure-mode detecting section
110: New-failure-mode registering section
1601: Failure-tendency change detecting section
DB1: Field data database
DB2: Failure mode database
DB3: Design production operation database

What is claimed is:

1. A field data monitoring device comprising:
a field data database in which field data is accumulated;
a failure mode database in which a failure mode list and a failure-mode word-probability table are recorded, the failure mode list recording names of failure modes of products and occurrence probabilities of each of the failure modes, and the failure-mode word-probability table holding appearance probabilities of words described in the field data for each of the failure modes;
a design production operation database in which data on design, production, and operations of the products is accumulated;
a failure-mode estimating section that calculates attribution probabilities of the field data to each of the failure modes based on information of the occurrence probabilities of the failure modes and the appearance probabilities of the words in the failure mode database, the failure-mode estimating section classifying the field data according to the failure modes based on results of calculating the attribution probabilities; and
a failure-mode cause finding section that extracts conditions under which the failure modes easily occur, the conditions being extracted from the data accumulated in the design production operation database, the data being data of the products associated with the field data classified by the failure-mode estimating section.

2. The field data monitoring device according to claim 1,
wherein the field data includes at least information of items related to states of failures of the products when maintenance related to failures of the products is performed, and
wherein the field data monitoring device comprises a failure-mode data initial-building section that records, in the failure mode database, information of appearance probabilities of words used in the items for each of the items.

3. The field data monitoring device according to claim 1, comprising:
a new-failure-mode detecting section that detects a new failure mode based on attribution probabilities to each of the failure modes calculated by the failure-mode estimating section.

4. The field data monitoring device according to claim 3,
wherein the new-failure-mode detecting section determines that the new failure mode is likely to have occurred when the attribution probabilities to each of the failure modes, calculated by the failure-mode estimating section, indicate values approximate to each other.

5. The field data monitoring device according to claim 3, comprising:
a new-failure-mode registering section that receives a name of the new failure mode and information of the field data corresponding to the new failure mode from a user; and
a failure-mode data updating section that updates the failure mode database based on the new failure mode and the information of the field data corresponding to the new failure mode, which are input to the new-failure-mode registering section by the user.

6. The field data monitoring device according to claim 1, comprising:
a failure-tendency change detecting section that detects changes in occurrence tendency of each of the failure modes and notifies the detected changes to a user.

7. A field data monitoring method comprising the steps of:
preparing a field data database in which field data is accumulated, a failure mode database in which a failure mode list and a failure-mode word-probability table are recorded, the failure mode list recording names of failure modes of products and occurrence probabilities of each of the failure modes, and the failure-mode word-probability table holding appearance probabilities of words described in the field data for each of the failure modes, and a design production operation database in which data on design, production, and operations of the products is accumulated;
calculating attribution probabilities of the field data to each of the failure modes based on information of the occurrence probabilities of the failure modes and the appearance probabilities of the words in the failure mode database, and classifying the field data according to the failure modes based on results of calculating the attribution probabilities, and
extracting conditions under which the failure modes easily occur, the conditions being extracted from the data accumulated in the design production operation database and indicating the products associated with the classified field data.

8. The field data monitoring method according to claim 7,
wherein the field data includes at least information of items related to states of failures of the products when maintenance related to failures of the products is performed, and
wherein the field data monitoring method comprises the step of recording, in the failure mode database, information of appearance probabilities of words used in the items for each of the items.

9. The field data monitoring method according to claim 7, comprising the step of:
detecting a new failure mode based on the calculated attribution probabilities to each of the failure modes.

10. The field data monitoring method according to claim 9, comprising the step of:
determining that the new failure mode is likely to have occurred when the calculated attribution probabilities to each of the failure modes indicate values approximate to each other.

11. The field data monitoring method according to claim 9, comprising the steps of:
receiving a name of the new failure mode and information of the field data corresponding to the new failure mode from a user; and
updating the failure mode database based on the new failure mode and the information of the field data corresponding to the new failure mode, which are input by the user.

12. The field data monitoring method according to claim 7, comprising the step of:
detecting changes in occurrence tendency of each of the failure modes and notifying the detected changes to a user.

13. A field data display device that configures a display screen of a product by using field data,
wherein the field data includes at least information of items related to states of failures of the product when maintenance related to a failure of the product is performed,
wherein the field data display device classifies the field data into clusters based on appearance numbers of times of words used in the items for each of the items, and
wherein the field data display device displays the classified field data on the display screen in chronological order or with lines.

14. A field data display device that configures a display screen of a product by using field data,
wherein the field data includes at least information of items related to states of failures of the product when maintenance related to a failure of the product is performed,
wherein the field data display device classifies the field data into clusters based on appearance numbers of times of words used in the items for each of the items, and
wherein the field data display device displays a list of the items of the classified field data on the display screen.

15. A field data display device that configures a display screen of a product by using field data,
wherein, for a failure mode to be analyzed, the field data display device extracts a combination of characteristic amounts with high probabilities of failure from the field data of the failure mode and design production data of the product and displays a name of the failure mode and a condition under which a failure easily occurs on the display screen.

16. A field data display device that configures a display screen of a product by using field data,
wherein the field data display device displays, based on information of appearance probabilities of words used in the field data, the field data including the attribution probabilities to each of the failure modes and information entropy calculated from the attribution probabilities to each of the failure modes,
wherein the field data display device displays the attribution probabilities to each of the failure modes and the information entropy for each of the field data on the display screen, and
wherein the information entropy is represented by values indicating a variation in the attribution probabilities to the failure modes.
